(19) United States
(12) Patent Application Publication
(10) Pub. No.: US 2006/0254153 A1
(43) Pub. Date: Nov. 16, 2006

(54) Security door

(76) Inventor: Paul Clancy, Leeds (GB)

Correspondence Address: DAVID A. GUERRA;INTERNATION PATENT GROUP, LLC, 10TH FLOOR, 610 8TH AVENUE S.W., CALGARY, AB, T2P 1G5, CA

(21) Appl. No.: 10/554,360

(22) PCT Filed: May 13, 2004
(86) PCT No.: PCT/GB04/02060

§ 371 Date: Oct. 25, 2005

(30) Foreign Application Priority Data
May 20, 2003 (GB) 03115664

(51) Int. Cl. E06B 3/00

(52) U.S. Cl. 49/501

(57) ABSTRACT

A security door is provided comprising a solid body, and a metal gate, said solid body comprising substantially a single type of material, wherein the metal gate is embedded in the solid body. Methods for constructing the security door are provided for solid bodies comprising plywood, wood, chipboard, fiberboard, fiberglass, rigid polymer foam, paper pulp, or pressed cardboard.

### FIELD OF THE INVENTION

The present invention relates to doors, and in particular to security doors.

### BACKGROUND OF THE INVENTION

Doors are particularly vulnerable to attack by intruders wishing to break into a property or any other location that is required to be kept secure. Doors may be broken, allowing intruders easy access into a property, and an easy exit from the property with any goods that have been stolen. A door leaf has several weak points that can be exploited by an intruder, such as panels of either wood or glass that may be broken, and the area around the locks.

Several solutions exist to impede the access of intruders. A metal gate may be placed in front of the door that prevents an intruder from getting access to the door itself. However, most metal gates have gaps between the bars of the gate which can be exploited by an intruder with a jemmy or bolt cutters to distort or cut the gate, thereby allowing access. Furthermore, the presence of a metal gate in front of a door is not aesthetically pleasing and takes up more room than a door on its own, and so most householders would prefer not to have a metal gate.

FIG. 1 illustrates schematically a cross-section through the thickness of a prior art sandwich construction security door 100, comprising a first metal sheet 101, and a second metal sheet 102, wherein the metal sheets surround a core 103. In some prior art doors, the core 103 comprises a cardboard honeycomb that provides thermal insulation and soundproofing. Alternatively, the core 103 may comprise a softwood sub frame and polystyrene. For both these types of door, the metal sheets may be pressed and sprayed to give the appearance of timber, or a decorative veneer may be placed on the outside of one or more of the metal sheets. These doors are expensive, and are generally not used in the domestic market, but used rather more for internal security doors in, for example, laboratories and banks.

GB 2186234 discloses a reinforced door made of a sandwich construction comprising two outer layers with a layer of rigid foam sandwiched between the two outer layers. A metal mesh is embedded in the foam. However, sandwich construction doors comprising two outer layers and an inner core may be attacked by a determined intruder by stripping away an outer layer, removing a portion of the foam, and removing a portion of the metal mesh with bolt cutters.

Attempts have been made to reinforce solid timber doors by drilling holes through a height or a width of the door leaf and inserting reinforcing bars through the drilled holes. This process is time consuming and expensive, and only provides reinforcements through either the length or the width, but not the length and width at the same time.

It would be advantageous to provide a solid door that can resist attack from a determined intruder without compromising the aesthetic qualities of the door.

### SUMMARY OF THE INVENTION

The inventor has devised a door, and a method of forming a door, in which a reinforcing metal gate is embedded into a solid body, such that it is almost impossible for a determined intruder to strip away the body around the metal gate and attack the metal gate with a jemmy or bolt cutters.

According to a first aspect of the present invention there is provided a door comprising:

a solid body comprising substantially a single type of material; and

a metal gate;

wherein said metal gate is embedded in said solid body.

Preferably, said metal gate comprises a plurality of bars, said bars having at least one cross-sectional dimension of at least 6 mm.

Preferably said metal gate comprises a network of bars, said bars being connected by welding.

Preferably said solid body comprises substantially a single type of material selected from any one of the following types:

plywood;

chipboard;

fiberboard;

wood;

fiberglass;

paper pulp;

pressed cardboard;

rigid polymer foam.

Preferably said metal gate comprises at least one hinge located at an opposite end to a leading edge of said door, said hinge being configured to pivotally connect said door to a supporting surface.

Preferably said metal gate comprises a section of machineable material located between said metal gate and said hinge; and

said hinge is in indirect contact with said metal gate using a hinge pin;

whereby an overall width of said door may be adjusted by reducing a thickness of said section of machineable material.

Preferably said machineable material comprises wood.

Preferably a decorative layer is positioned on at least one surface of said door.

Preferably said decorative layer comprises a uPVC veneer.

Alternatively, said decorative layer comprises a timber veneer.

Preferably, a first decorative layer is positioned on a first surface of said door and a second decorative layer is positioned on a second surface of said door, wherein said first decorative layer comprises a different type of material to said second decorative layer.

Preferably said door, said aperture having at least one dimension no greater than 250 mm.

Preferably at least one aperture is provided in said door, said aperture having at least one dimension no greater than 250 mm.

According to a second aspect of the present invention there is provided a method of constructing a door comprising:

applying adhesive to a surface of a first plywood skin;

locating a metal gate on said surface of said first plywood skin, said metal gate comprising at least one aperture;

locating at least one plywood infill in said at least one aperture.

applying adhesive to a surface of a second plywood skin;

locating said surface of said second plywood skin on said metal gate and said at least one plywood infill, such that said second plywood skin is located substantially in opposition to said first plywood skin;

applying pressure to said first plywood skin and said second plywood skin in a direction perpendicular to said surface of said first and second plywood skins;

whereby said pressure causes said first plywood skin, said second plywood skin and said at least one plywood infill to form a contiguous solid plywood body around said metal gate.

Preferably, said metal gate comprises a plurality of bars, said bars having at least one cross-sectional dimension of at least 6 mm.

Preferably said metal gate comprises a network of bars, said bars being connected by welding.

Preferably said metal gate comprises at least one hinge located at an opposite end to a leading edge of said door, said hinge being configured to pivotally connect said door to a supporting surface.

Preferably said metal gate comprises a section of machineable material located between said metal gate and said hinge; and

said hinge is in indirect contact with said metal gate using a hinge pin;

whereby an overall width of said door may be adjusted by reducing a thickness of said section of machineable material.

Preferably said machineable material comprises wood.

Preferably the method comprises positioning a decorative layer on at least one surface of said door.

Preferably, said decorative layer comprises uPVC veneer.

Alternatively, said decorative layer comprises wood veneer.

Preferably, the method comprises providing at least one aperture in said door, said aperture having at least one dimension no greater than 250 mm.

According to a third aspect of the present invention there is provided a method of constructing a door comprising:

placing a required quantity of slurry in a mould for a door;

placing a metal gate in said mould for a door;

pressing said slurry to remove a required quantity of liquid;

whereby said slurry sets to form a contiguous solid body around said metal gate.

Preferably, said metal gate comprises a plurality of bars, said bars having at least one cross-sectional dimension of at least 6 mm.

Preferably, said metal gate comprises a network of bars, said bars being connected by welding.

Preferably, said metal gate comprises at least one hinge located at an opposite end to a leading edge of said door, said hinge being configured to pivotally connect said door to a supporting service.

Preferably, said metal gate comprises a section of machineable material located between said metal gate and said hinge; and

said hinge is in indirect contact with said metal gate using a hinge pin;

whereby an overall width of said door may be adjusted by reducing a thickness of said section of machineable material.

Preferably, said machineable material comprises wood.

Preferably, the method comprises positioning a decorative layer on at least one surface of said door.

Preferably, said decorative layer comprises uPVC or timber veneer.

Preferably, the method comprises providing at least one aperture in said door, said aperture having at least one dimension no greater than 250 mm.

Preferably, said contiguous solid body comprises substantially a single type of material selected from any one of the following types:

chipboard;

fiberglass;

paper pulp.

According to a fourth aspect of the present invention there is provided a method of constructing a door comprising:

machining slots into a surface of a first skin, said slots being configured to interlock with a metal gate;

locating a metal gate in said slots of said first skin;

machining slots into a surface of a second skin, said slots having a configuration suitable to interlock with said metal gate;

positioning said second skin over said metal gate, such that said slots in said surface of said second skin interlock with said metal gate; and

fixing said first skin to said second skin, whereby said first skin and said second skin form a contiguous solid body comprising substantially a single type of material around said metal gate.

Preferably, said metal gate comprises a plurality of bars, said bars having at least one cross-sectional dimension of at least 6 mm.

Preferably, said metal gate comprises a network of bars, said bars being connected by welding.

Preferably, said metal gate comprises at least one hinge located at an opposite end to a leading edge of said door, said hinge being configured to pivotally connect said door to a supporting service.

Preferably, said metal gate comprises a section of machineable material located between said metal gate and said hinge; and

said hinge is in indirect contact with said metal gate using a hinge pin;

whereby an overall width of said door may be adjusted by reducing a thickness of said section of machineable material.

Preferably, said machineable material comprises wood.

Preferably, the method comprises positioning a decorative layer on at least one surface of said door.

Preferably, said decorative layer comprises uPVC veneer.

Alternatively, said decorative layer comprises wood veneer.

Preferably, the method comprises providing at least one aperture in said door, said aperture having at least one dimension no greater than 250 mm.

Preferably, said solid body comprises substantially a single type of material selected from any one of the following types:

fiberboard;

wood;

rigid polymer foam;

paper pulp.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a cross-section through the thickness of a prior art sandwich constuction security door.

FIG. 2 illustrates schematically the components of a door according to the first specific embodiment of the invention.

FIG. 3 illustrates a flow diagram showing the steps for constructing a door according to the first specific embodiment of the invention.

FIG. 4 illustrates schematically a perspective view of the components of a door according to the first specific embodiment of the invention.

FIG. 4A illustrates schematically a perspective view of a door showing a cutaway section of a solid body in which a metal gate is embedded.

FIG. 5 illustrates a flow diagram showing the steps for constructing a door according to the second specific embodiment of the invention.

FIG. 6 illustrates a flow diagram showing the steps for constructing a door according to the third specific embodiment of the invention.

FIG. 7 illustrates schematically plan cross-section view of a hinge connected to a door.

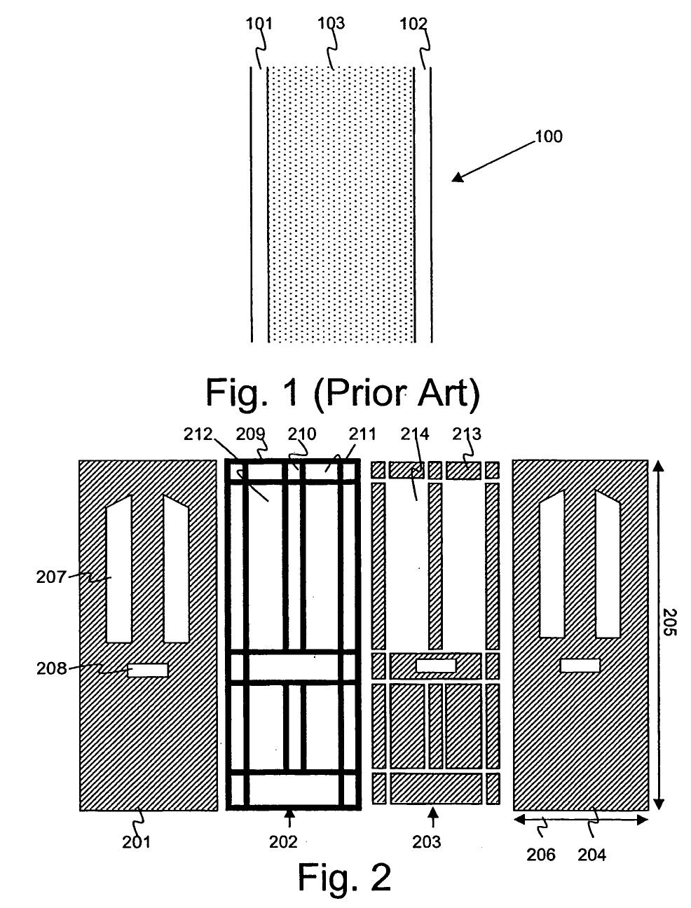

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well-known methods and structures have not been described in detail so as not to unnecessarily obscure the description.

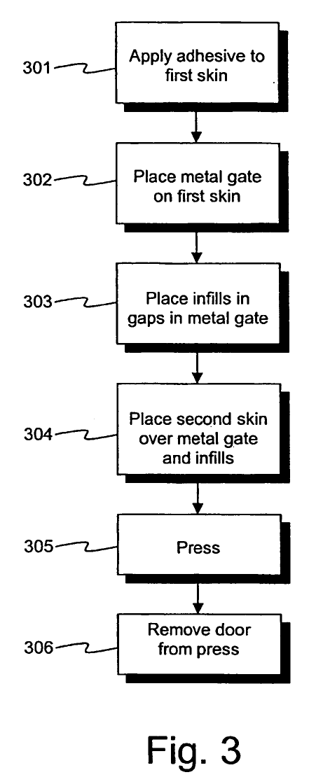

Referring to FIG. 2 herein, there is illustrated schematically the components of a door according to the first specific embodiment of the invention.

The door comprises a first plywood skin 201, a metal gate 202, a plurality of plywood infills 203 and a second plywood skin 204. The door has a height 205 and a width 206.

The plywood skins 201, 204 may comprise apertures suitable for glazing 207 or a letterbox 208. The apertures 207, 208 must be sufficiently small to prevent access for a small child. It has been found that an aperture with at least one dimension no greater than 250 mm is suitable.

The metal gate 202 comprises any suitable metal to provide reinforcement, such as mild steel, and has a height and a width substantially the same as that of the door. The metal gate 202 comprises a network of bars, for example horizontal bars 209 and vertical bars 210, although many configurations of bars are possible. The bars 209, 210 have a cross-section suitable for reinforcement, for example strip, tubular or box section. The bars are attached to each other by conventional means, for example welding or bolting. It has been found that strip mild steel with a thickness of at least 6 mm is suitable. The metal gate 202 also comprises apertures, for example 211 and 212.

The plywood infills 203 are of suitable dimensions to fit substantially into the apertures of the metal gate. The dimensions are chosen to allow for expansion of the plywood infills, thereby preventing warping of the door. Infill 213 is configured to fit into aperture 211. If glazing is required, aperture 212 is left without an infill, and if glazing is not required an infill of suitable dimensions to fit aperture 212 is placed in aperture 212.

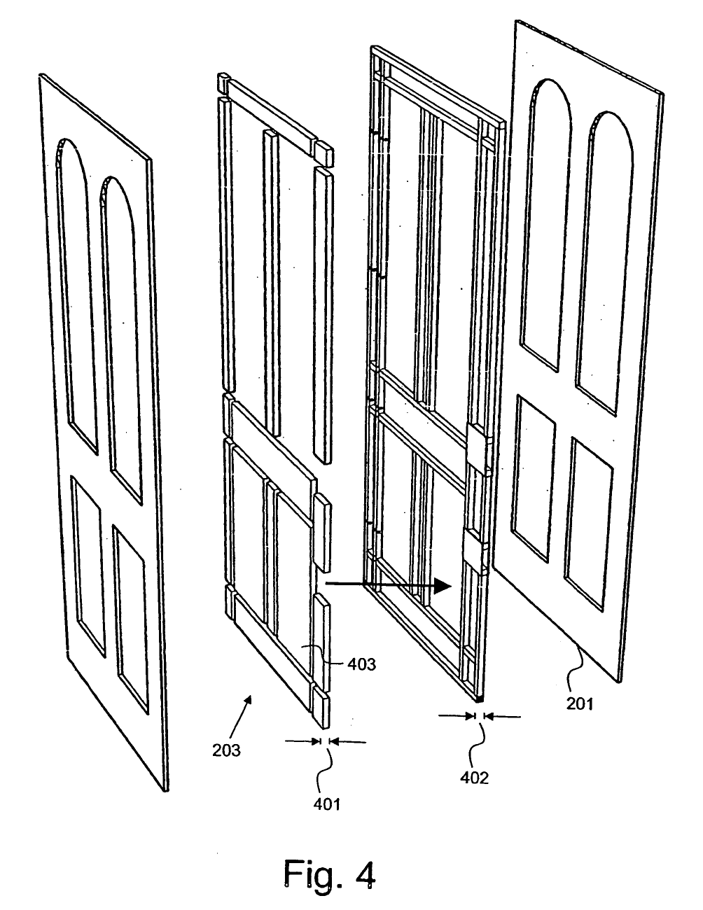

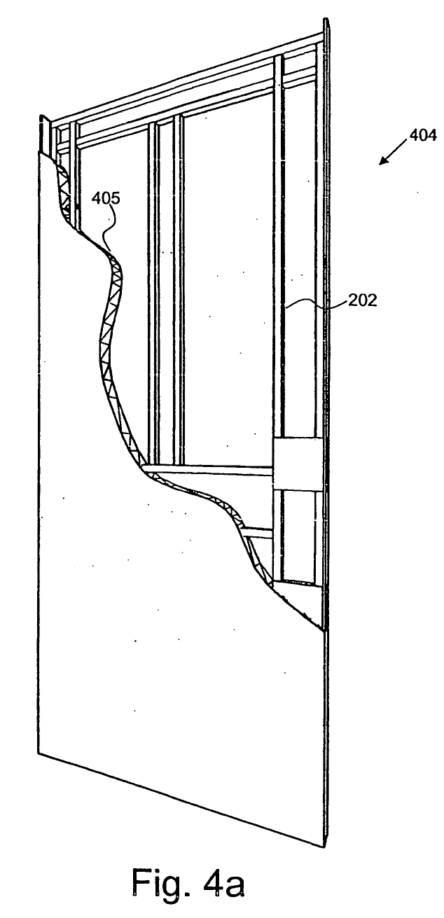

Referring to FIG. 3 herein, there is illustrated a flow diagram showing the steps for constructing a door according to the first specific embodiment of the invention. Furthermore, referring to FIG. 4 herein there is illustrated schematically a perspective view of the components of a door according to the first specific embodiment of the invention. These figures illustrate how the components of the door are assembled.

Adhesive is applied 301 to a surface of the first plywood skin 201. The metal gate 202 is placed 302 onto the first plywood skin 201. Infills 203 are located 303 in apertures of the metal gate 202 such that a surface of each infill is substantially in contact with the adhesive on the first plywood skin 201. A thickness 401 of the plywood infills 203 is substantially the same as a thickness 402 of the bars. Adhesive is applied to a surface of the second plywood skin 204, and the second plywood skin 204 is located 304 over the metal gate 202 and the infills 203, such that the adhesive on the surface of the second plywood skin 204 is substantially in contact with the metal gate 202 and the plywood infills 203.

The adhesive used comprises any suitable adhesive, such as a water-based resin.

The first plywood skin 201, the metal gate 202, the plywood infills 203 and the second plywood skin 204 are then pressed together to form a door. A suitable press is used, for example a hot or cold veneer press. Any pressure used to form plywood may be used although it has been found that pressures between 1500 and 2000 psi are optimal. It is advantageous to press the door at elevated temperature, as this speeds up the manufacturing process, although the door may be pressed at room temperature.

The pressing process is substantially the same as that used to manufacture plywood from timber veneer. On pressing the first plywood skin 201, the plywood infills 203 and the second plywood skin 204, a solid body of a substantially uniform composition of plywood is formed. The solid plywood body forms a contiguous body around the metal gate 202, thereby concealing the gate. By substantially uniform composition, it is meant that the composition of the contiguous solid body around the metal gate is substantially uniform throughout its thickness, and the composition does not vary by the addition of sandwich layers and the like.

Referring to FIG. 4A herein, there is illustrated schematically a perspective view of a door showing a cutaway section of a solid body in which a 10 metal gate is embedded. The door 404 comprises a metal gate 202 substantially embedded in the solid body 405, wherein the solid body comprises a substantially a single type of material.

The solid body of plywood comprises substantially a single type of material. The term “material” is used to denote bulk material. In this instance, the bulk material is plywood, the plywood consisting of layers of timbers and resins. A solid body comprising a single type of material may include regions of differing densities, laminate thicknesses, or other properties, provided that the material type remains the same.

The metal gate 202 is therefore embedded in the solid body of plywood and is substantially concealed. An advantage of the plywood forming a contiguous body around the metal gate 202 is that it makes it almost impossible for an intruder to strip away a surface layer, as can be done with prior art sandwich construction doors. Furthermore, even if a section of the metal gate could be exposed, the plywood infills 203 in the apertures of the metal gate 202 prevent the use of a bolt cutter or jemmy to distort or cut the metal gate.

Alternatively, the solid body used to form a contiguous body around the metal gate comprises a rigid polymer foam, paper pulp or pressed cardboard.

According to a second specific embodiment of the invention, the solid body used to form a contiguous body around the metal gate comprises chipboard. Chipboard is conventionally made from a water-based slurry containing timber and an adhesive. The slurry is then pressed in a mould to drive off the water, forming a dry moulded section of chipboard.

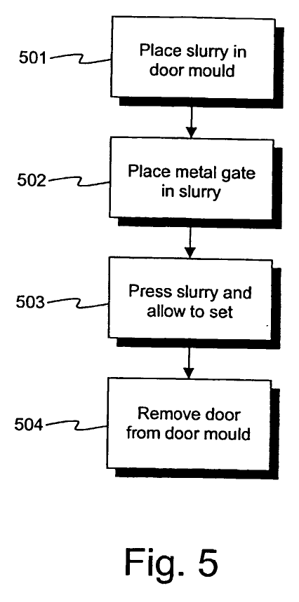

Referring to FIG. 5 herein, there is illustrated a flow diagram showing the steps for constructing a door according to the second specific embodiment of the invention. A required quantity of chipboard slurry is placed 501 in a mould for the door. The metal gate 202 is then placed 502 in the mould with the chipboard slurry. The slurry is then pressed 503 to drive off water and form a solid chipboard body of substantially a single type of material, which forms a door comprising a contiguous solid body around the metal gate 202. The door can then be removed 504 from the mould.

Apertures for glazing or a letterbox are provided, if required, by machining apertures in the chipboard or having a mould of a suitable shape to provide apertures in the door.

Alternatively, the solid body used to form a contiguous body around a metal gate comprises fiberglass or paper pulp. The manufacturing process is substantially the same as that for manufacturing a door comprising a chipboard solid body.

According to a third specific embodiment of the invention, the solid body used to form a contiguous body around the metal gate comprises solid timber, medium density fibreboard (MDF), pressed cardboard, or a rigid polymer foam.

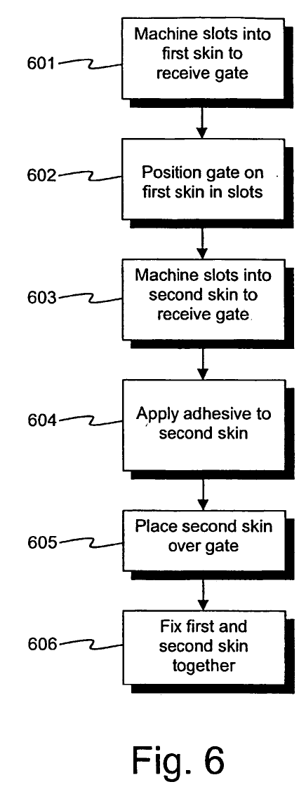

Referring to FIG. 6 herein, there is illustrated a flow diagram showing the steps for constructing a door according to the third specific embodiment of the invention. A first skin comprising MDF or solid timber has a surface, into which slots are machined 601. The configuration of the slots is suitable to receive the metal gate 202. The metal gate 202 is then located 602 in the slots of the first surface. Slots are also machined 603 into a surface of a second skin. The second skin comprises solid Umber or MDF. The configuration of the slots is suitable to receive the metal gate 202. A combined depth of the slots in the first skin and second skin is substantially the same as the thickness 402 of the metal gate 202 and optionally a gap is left to allow for expansion of the solid body. Adhesive is applied to the surface of the second skin 604, and the second skin is located 605 such that the metal gate 202 interlocks with the slots. The first and second skin are then fixed together 606 by allowing the adhesive to set. Other fixing means may be in place of, or in addition to adhesive, for example bolts or screws.

The MDF or solid timber forms a contiguous solid body of substantially a single type of material around the metal gate 202. Apertures for glazing or a letterbox are provided, if required, by machining apertures in the MDF or solid timber. These apertures may be machined either before the two MDF or solid timber skins are joined together around the metal gate 202 or after the two MDF or solid timber skins are joined together around the metal gate 202.

In an alternative arrangement, compatible with any of the above embodiments, a decorative layer-may be formed on one or more surfaces of the door. Such decorative layers are known in the art, and typically comprise uPVC or timber veneers.

In a further alternative arrangement, compatible with any of the embodiments, a first decorative layer may be formed on one surface of a door, and a second decorative layer may be formed on a second surface of the door. The decorative layers may comprise different materials. This arrangement allows, for example, a uPVC decorative layer to be positioned on one surface of a door, and a timber decorative layer on another surface of a door. Either decorative layer may be chosen to match the surrounding decor.

In a further alternative arrangement, compatible with any of the above embodiments, at least one hinge is provided formed on the metal gate 202. The hinge is a weak point of the door, and the metal gate is the strongest part of the door, and so it is desirable to have hinges formed directly on the metal gate rather on the solid body forming a contiguous body around the metal gate. The hinge is used to pivotably connect the door to a supporting surface, and is located on an opposite edge of the door to a leading edge of the door.

In a further alternative arrangement, compatible with any of the above embodiments, means is provided for adjusting an overall width of the door, allowing a standard size door to be manufactured and adjusted if necessary to fit door apertures of different widths.

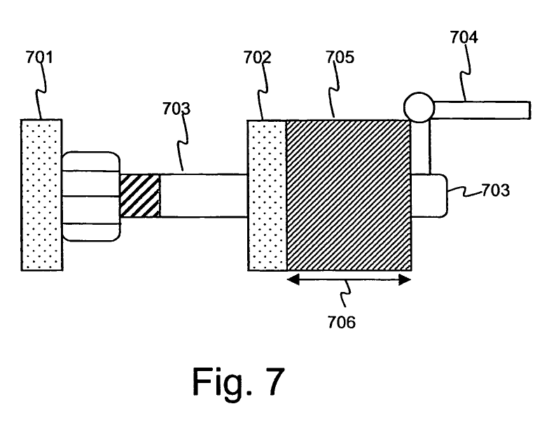

Referring to FIG. 7 herein, there is illustrated schematically plan cross-section view of a hinge connected to a door. The metal gate 202 comprises at least two substantially vertical bars 701, 702. A hinge pin 703 abuts the first bar 701 and passes through a hole in the second bar 702. A hinge 704 is connected to the hinge pin 703. A section of machinable material 705 is located between the second bar 702 and the hinge 704. The machinable material 705 comprises a hole through which the hinge pin 703 is passed. In this way, the hinge 704 is indirectly attached to the bars 701, 702 of the metal gate 202.

The section of machinable material 705 has a thickness 706. The thickness 706 is altered by machining the material 705 to a required thickness 706, thereby allowing the overall width of the door to be adjusted to fit a variety of door aperture width.

1-43. (canceled)

44. A door, comprising:
a solid body having substantially a single type of material;
a metal gate having a plurality of bars, said metal gate being embedded in said solid body; and
at least one hinge located at an opposite end to a leading edge of said door, said hinge being configured to pivotally connect said door to a supporting surface.

45. The door as set forth in claim 44, wherein said bars having at least one cross-sectional dimension of at least 6 mm.

46. The door as set forth in claim 44, wherein said solid body being made from a material selected from the group consisting of plywood, chipboard, fiberboard, wood, fiberglass, paper pulp, pressed cardboard, and rigid polymer foam.

47. The door as set forth in claim 44 further comprising a section of machineable material located between said metal gate and said hinge, said hinge is in indirect contact with said metal gate using a hinge pine, whereby an overall width of said door may be adjusted by reducing a thickness of said section of machineable material.

48. The door as set forth in claim 44 further comprising a first decorative layer positionable on a first surface of said door, and a second decorative layer positionable on a second surface of said door, wherein said first decorative layer comprises a different type of material to said second decorative layer.

49. The door as set forth in claim 44, wherein said door defines an aperture, said aperture having at least on dimension no greater than 250 mm.

50. A method of constructing a door having solid body and a metal gate embedded in said solid body, said method comprising:
applying adhesive to a surface of a first plywood skin;
locating a metal gate on said surface of said first plywood skin, said metal gate comprising at least one aperture;
locating at least one plywood infill in said at least one aperture;
applying adhesive to a surface of a second plywood skin;
locating said surface of said second plywood skin on said metal gate and said plywood infill, such that said second plywood skin is located substantially in opposition to said first plywood skin;
applying pressure to said first plywood skin and said second plywood skin in a direction perpendicular to said surface of said first and second plywood skins;
whereby said pressure causes said first plywood skin, said second plywood skin, and said plywood infill to form a contiguous solid plywood body around said metal gate.

51. The method as set forth in claim 50, wherein said metal gate comprises of a plurality of bars, said bars having at least on cross-sectional dimension of at least 6 mm.

52. The method as set forth in claim 50 further comprising the step of locating at least one hinge at an opposite end to a leading edge of said door, said hinge being configured to pivotally connect said door to a support surface.

53. The method as set forth in claim 52 further comprising the step of locating a section of machineable material between said metal gate and said hinge.

54. The method as set forth in claim 54 further comprising the step of adjusting the overall width of said door by reducing a thickness of said section of machineable material.

55. The method as set forth in claim 50 further comprising the step of positioning a decorative layer on at least one surface of said door.

56. The method as set forth in claim 50 further comprising the step of defining an aperture in said door, said aperture having at least one dimension no greater than 250 mm.

57. A method of constructing a door having a metal gate embedded in said door, said method comprising:
placing a slurry in a mould for a door;
placing a metal gate in said mould for said door;
pressing said slurry to remove a quantity of liquid; and
whereby said slurry sets to form a contiguous solid body around said metal gate.

58. The method as set forth in claim 57, wherein said metal gate comprises a plurality of bars, said bars having at least one cross-sectional dimension of at least 6 mm.

59. The method as set forth in claim 57 further comprising the step of locating at least one hinge at an opposite end to a leading edge of said door, said hinge being configured to pivotally connect said door to a support surface.

60. The method as set forth in claim 59 further comprising the step of locating a section of machineable material between said metal gate and said hinge.

61. The method as set forth in claim 60 further comprising the step of adjusting the overall width of said door by reducing a thickness of said section of machineable material.

62. The method as set forth in claim 57 further comprising the step of positioning a decorative layer on at least one surface of said door.

63. The method as set forth in claim 57 further comprising the step of defining an aperture in said door, said aperture having at least one dimension no greater than 250 mm.
